(19) United States
(12) Patent Application Publication
(10) Pub. No.: US 2023/0300163 A1
(43) Pub. Date: Sep. 21, 2023

(54) GENERALIZED IDENTITY MODULE

(71) Applicant: Recorded Future, Inc., Somerville, MA (US)

(72) Inventors: Staffan Truvé, Alingsas (SE); Bill Ladd, Watertown, MA (US)

(21) Appl. No.: 18/122,423

(22) Filed: Mar. 16, 2023

Related U.S. Application Data
(60) Provisional application No. 63/320,482, filed on Mar. 16, 2022.

(51) Int. Cl. H04L 9/40

(52) U.S. Cl. CPC H04L 63/1433

(57) ABSTRACT

Disclosed, in one general aspect, is a computer network security monitoring method that includes continuously gathering and storing machine-readable identity information records of different types for different individuals, and continuously deriving and storing general-purpose blended identity risk profiles for the individuals based on the continuously gathered machine-readable identity information records of the different types.

### CROSS-REFERENCE TO RELATED APPLICATION

This application claims priority to U.S. Provisional Application No. 63/320,482 filed Mar. 16, 2022 and herein incorporated by reference.

### FIELD OF THE INVENTION

This invention relates to methods and apparatus for evaluating security and/or protecting systems on large computer networks, such as the Internet.

### BACKGROUND OF THE INVENTION

A number of services have been developed to help mitigate the effects of identity breaches on the internet. These include services that provide access to leaked credentials, services that verify identity against government data sources, services that provide background on individuals, and services that detect abnormal online behavior. Despite the availability of these and other types of services, breach of identity remains a significant problem in e-commerce, corporate information security, and other types of networked computer interactions.

### SUMMARY OF THE INVENTION

In one general aspect, the invention features a computer network security monitoring method that includes continuously gathering and storing machine-readable identity information records of different types for different individuals, and continuously deriving and storing general-purpose blended identity risk profiles for the individuals based on the continuously gathered machine-readable identity information records of the different types.

In preferred embodiments, the step of continuously gathering and storing can gather and store a first type of identity information records from the following types of identity information records: leaked credential information records, leaked personal information records, validated identity information records from an identity validation service, and payment credential information from a payment monitoring service. The step of continuously gathering and storing can also gather and store a second type of identity information records from the following types of identity information records: leaked credential information records, leaked personal information records, validated identity information records from an identity validation service, and payment credential information from a payment monitoring service. The method can further include continuously gathering and storing further machine-readable identity information records of a third type, and the step of continuously deriving and storing can be further based on the continuously gathered machine-readable identity information records of the third type. The step of continuously gathering and storing can gather and store a third type of identity information records from the following types of identity information records: leaked credential information records, leaked personal information records, validated identity information records from an identity validation service, and payment credential information from a payment monitoring service. The risk profile can include a numerical blended identity score. The method can further include reconciling records that belong to a same individual for at least one of the information record types. At least some of the information records of the first and second types can be obtained from dark internet sources. The method can further include providing access to the general-purpose blended identity risk profiles via an application programming interface. The continuously derived and stored general-purpose blended identity risk profiles can reflect relationships between at least some of the individuals for which records are stored. The continuously derived and stored general-purpose blended identity risk profiles reflect professional relationships between at least some of the individuals for which records are stored.

In another general aspect, the invention features a computer network security monitoring system that includes a first identity information gathering interface operative to continuously receive and store machine-readable identity information records of a first type for different individuals, a second identity information gathering interface operative to continuously receive and store machine-readable identity information records of a second type for different individuals, and a general-purpose blended identity scoring that is operative to access machine-readable identity information records of the first type gathered by the first identity information gathering interface, operative to access machine-readable identity information records of the second type gathered by the first identity information gathering interface, and operative to derive risk profiles for each of a plurality of the individuals based on both the continuously gathered machine-readable identity information records of the first type and the continuously gathered machine-readable identity information records of the second type. In preferred embodiments, the system can further include a records reconciliation subsystem operative to reconcile records that belong to a same individual for at least one of the information record types.

In a further general aspect, the invention features a computer network security monitoring system that includes means for continuously gathering and storing machine-readable identity information records of a first type for different individuals, means for continuously gathering and storing machine-readable identity information records of a second type for different individuals, and means for continuously deriving and storing general-purpose blended identity risk profiles for each of a plurality of the individuals based on both the continuously gathered machine-readable identity information records of the first type and the continuously gathered machine-readable identity information records of the second type.

Systems according to the invention can help network administrators to detect, understand, and remedy risks posed by identity breaches.

### BRIEF DESCRIPTION OF THE DRAWING I

FIG. 1 is a block diagram of an illustrative network security system according to the invention;

FIG. 2 is a flowchart illustrating operations of the system of FIG. 1; and

FIG. 3 is a data diagram illustrating relationships between records in the system of FIG. 1.

### DETAILED DESCRIPTION OF AN ILLUSTRATIVE EMBODIMENT

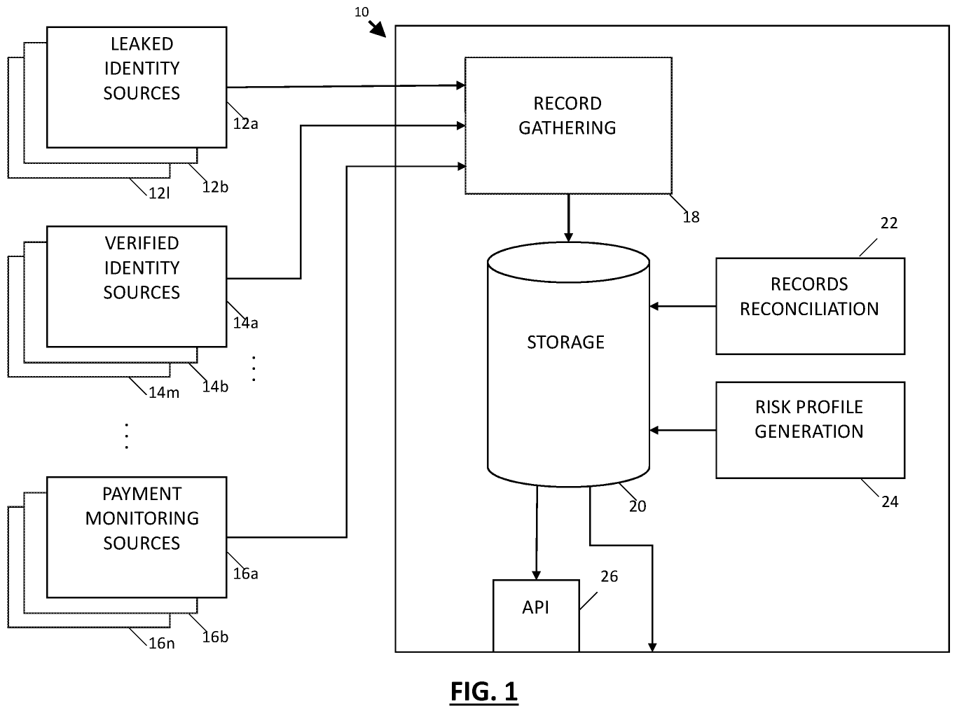

Referring to FIG. 1, a network security system 10 includes a record gathering subsystem 18 with at least one input for receiving data from a number of different types of sources of identity information, such as leaked identity sources 12a, 12b . . . 12i, verified identity sources 14a, 14b . . . 14m, and payment monitoring sources 16a, 16b . . . 16n. The retrieved information is formatted and stored in a storage unit 20, such as a database. A records reconciliation subsystem 22 reconciles the stored records from different sources, and a risk profile generation subsystem 24 generates risk profiles for the stored records. The resulting organized and enriched identity data can be accessed by other systems in bulk or via an Application Programming Interface (API) 26.

The network security system 10 is preferably implemented as part of a larger system that also includes other security subsystems. These systems can users to access and use the organized identity data along with other types of threat data to perform a larger set of organizational security functions. In one embodiment, the security monitoring system includes features of the Recorded Future Temporal Analytics Engine, which is described in more detail in U.S. Pat. No. 8,468,153 entitled INFORMATION SERVICE FOR FACTS EXTRACTED FROM DIFFERING SOURCES ON A WIDE AREA NETWORK and in U.S. Publication No. 20180063170 entitled NETWORK SECURITY SCORING. Related technology is also discussed in the application entitled MALWARE VICTIM IDENTIFICATION, Ser. No. 17/516,175, and the application entitled PIPELINED MALWARE INFRASTRUCTURE IDENTIFICATION, Ser. No. 17/516,046, both filed on Nov. 1, 2021. The documents referenced directly and indirectly in this paragraph are all herein incorporated by reference.

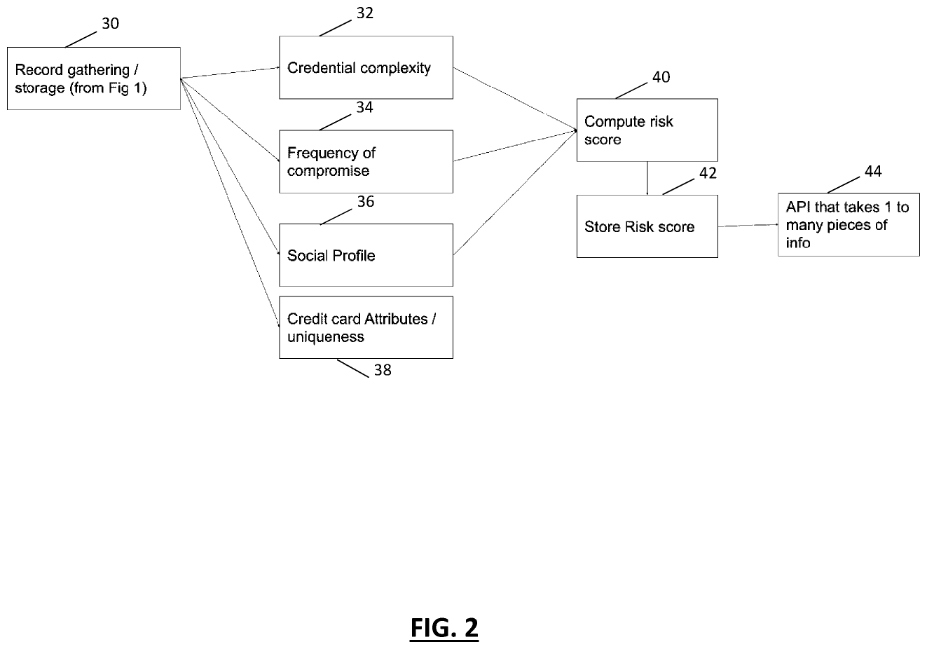

In operation, referring also to FIG. 2, subsystems in the security system 10 retrieve identity information records and compute analytics such as uniqueness, social profile inputs (demographics, geography), and other attributes for the stored identity data. A scoring/risk profiling subsystem uses these inputs and analytics to compute risk profiles, which can include numerical risk scores. These risk scores are then stored and available via the API.

In one embodiment, gathered records are analyzed and enriched for credential complexity 32, frequency of compromise 34, social profile 36, and credit card attributes/uniqueness 38. Risk score computation logic is operative to compute 40 and store 42 risk scores from this information. The stored information and scores can then be accessed via the API 44.

To gain a more holistic view of an identity and its risk, the system combines physical identity information with digital identity data. This includes intelligence related to devices, locations, identities and past behaviors to accurately distinguish between trusted and fraudulent users.

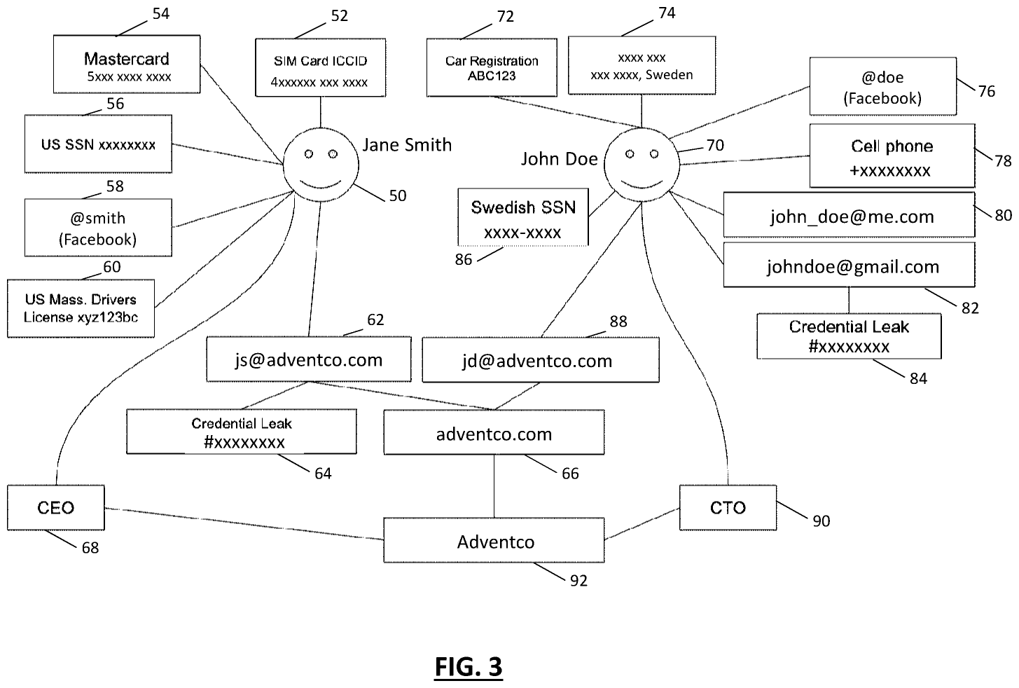

Referring also to FIG. 3, identity information can be stored in such a way that relationships between different types of data can be explored. A particular individual “A” 50, might be associated with a SIM card number 52, a credit card 54, a US Social Security number 56, a social media profile 58, a driver's license from a particular US state 60, and a professional email address 62. One or more credential leaks 64 can also be associated with the email address 64.

Individual “A's” email address can be associated with a domain name 66, as well, and the domain name can be in turn associated with a corporate entity 92. The individual can further be associated with a professional employment position with the corporate entity 68.

Another individual “B” 70 might be associated with a car registration 72, an international address 74, a social media profile 76, a cell phone number 78, a first personal email address 80, and a second personal email address 82, which can be associated with one or more credential leaks 84. This individual can also be associated with a Swedish Social Security number 86, a professional email address 88, and a professional position 90. The professional email address may be associated with a domain and corporate entity 92, which in this case can be the same as was associated with the professional employment position and the professional email address of individual “A.”

Each individual can of course be associated with more than one of a particular type of credential, such as with several credit cards. And not all of an individual's information might be available in storage at any given time for any given purpose. Many other types of identity information data could be stored and made accessible, such as bank account numbers, passport numbers, or academic credentials.

The identity system can provide a programmatic interface to verify digital identities of individuals and machines by providing correlation of disparate data sources including open and closed source data elements. Identity compromises can be detected and retrievable on a per-user and bulk basis.

Correlating data elements from multiple sources to form a more complete picture of a user or machine identity that can then be used for the purposes of analyzing whether a given user's information matches what is known.

This solution incorporates information that is gained programmatically and via human interactions and combined. Various matching procedures are used to combine the disparate sources without a pre-specified linkage. Machine learning models and correlation rules are utilized to validate the relationships. The information will include user behavioral analysis from website traffic as well as information that has been leaked on closed and dark web sources.

The identity relationships accessible through the system 10 can be used to accomplish a variety of different tasks. These can include, for example, real-time prevention of login based on compromised identity information, identification and real-time prevention of fraudulent transactions based on multiple data points and risk calculated from compromised data, identification of identities frequently targeted with identity theft, and evaluating patterns of credential uniqueness across disparate applications.

The API may call in for one individual or with a series of information that may represent one to many users (i.e., there are multiple John Doe's in New York with the last 4 credit card of 4444). The API can provide the risk of this identity/transaction.

The system described above has been implemented in connection with digital logic, storage, and other elements embodied in special-purpose software running on a general-purpose computer platform, but it could also be implemented in whole or in part using virtualized platforms and/or special-purpose hardware. And while the system can be broken into the series of modules and steps shown in the various figures for illustration purposes, one of ordinary skill in the art would recognize that it is also possible to combine them and/or split them differently to achieve a different breakdown.

The embodiments presented above can benefit from temporal and linguistic processing and risk scoring approaches outlined in US Patent Publication No. 2020-0401961 entitled CROSS-NETWORK SECURITY EVALUATION, published Feb. 11, 2021 and US Patent Publication No. 2021-0042409 entitled AUTOMATED ORGANIZATIONAL SECURITY SCORING SYSTEM, published Dec. 24, 2020 and the documents they refer to. The documents referenced directly and indirectly in this paragraph are all herein incorporated by reference.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A computer network security monitoring method for a processor and a storage device including instructions configured to run on the processor, including:
continuously gathering and storing machine-readable identity information records of a first type for different individuals,
continuously gathering and storing machine-readable identity information records of a second type for different individuals, and
continuously deriving and storing general-purpose blended identity risk profiles for each of a plurality of the individuals based on both the continuously gathered machine-readable identity information records of the first type and the continuously gathered machine-readable identity information records of the second type.

2. The method of claim 1 wherein the step of continuously gathering and storing machine-readable identity information records of the first type gathers and stores a first type of identity information records from the following types of identity information records: leaked credential information records, leaked personal information records, validated identity information records from an identity validation service, and payment credential information from a payment monitoring service.

3. The method of claim 2 wherein the step of continuously gathering and storing machine-readable identity information records of the second type gathers and stores a second type of identity information records from the following types of identity information records: leaked credential information records, leaked personal information records, validated identity information records from an identity validation service, and payment credential information from a payment monitoring service.

4. The method of claim 3 further including a step of continuously gathering and storing further machine-readable identity information records of a third type, and wherein the step of continuously deriving and storing general-purpose blended identity risk profiles for each of a plurality of individuals is further based on the continuously gathered machine-readable identity information records of the third type.

5. The method of claim 4 wherein the step of continuously gathering and storing machine-readable identity information records of the third type gathers and stores a third type of identity information records from the following types of identity information records: leaked credential information records, leaked personal information records, validated identity information records from an identity validation service, and payment credential information from a payment monitoring service.

6. The method of claim 1 further including a step of continuously gathering and storing further machine-readable identity information records of a third type, and wherein the step of continuously deriving and storing general-purpose blended identity risk profiles for each of a plurality of individuals is further based on the continuously gathered machine-readable identity information records of the third type.

7. The method of claim 1 wherein the risk profile includes a numerical blended identity score.

8. The method of claim 1 further including reconciling records that belong to a same individual for at least one of the information record types.

9. The method of claim 1 wherein at least some of the information records of the first and second types is obtained from dark internet sources.

10. The method of claim 1 further including providing access to the general-purpose blended identity risk profiles via an application programming interface.

11. The method of claim 1 wherein the continuously derived and stored general-purpose blended identity risk profiles reflect relationships between at least some of the individuals for which records are stored.

12. The method of claim 1 wherein the continuously derived and stored general-purpose blended identity risk profiles reflect professional relationships between at least some of the individuals for which records are stored.

13. A computer network security monitoring system, including a processor and a storage device including instructions configured to run on the processor, including:
a first identity information gathering interface operative to continuously receive and store machine-readable identity information records of a first type for different individuals,
a second identity information gathering interface operative to continuously receive and store machine-readable identity information records of a second type for different individuals, and
a general-purpose blended identity scoring that is operative to access machine-readable identity information records of the first type gathered by the first identity information gathering interface, operative to access machine-readable identity information records of the second type gathered by the first identity information gathering interface, and operative to derive risk profiles for each of a plurality of the individuals based on both the continuously gathered machine-readable identity information records of the first type and the continuously gathered machine-readable identity information records of the second type.

14. The apparatus of claim 13 further including a records reconciliation subsystem operative to reconcile records that belong to a same individual for at least one of the information record types.

15. A computer network security monitoring system, including a processor and a storage device including instructions configured to run on the processor, including:
means for continuously gathering and storing machine-readable identity information records of a first type for different individuals,
means for continuously gathering and storing machine-readable identity information records of a second type for different individuals, and
means for continuously deriving and storing general-purpose blended identity risk profiles for each of a plurality of the individuals based on both the continuously gathered machine-readable identity information records of the first type and the continuously gathered machine-readable identity information records of the second type.
